(19) United States
(12) Patent Application Publication
(10) Pub. No.: US 2022/0006647 A1
(43) Pub. Date: Jan. 6, 2022

(54) ANONYMOUS SERVICE ACCESS

(71) Applicant: Hewlett-Packard Development Company, L.P., Spring, TX (US)

(72) Inventors: Thalia May Laing, Bristol (GB); Joshua Serratelli Schiffman, Bristol (GB); Daniel Cameron Ellam, Bristol (GB); Jonathan Francis Griffin, Bristol (GB)

(73) Assignee: Hewlett-Packard Development Company, L.P., Spring, TX (US)

(21) Appl. No.: 17/283,358

(22) PCT Filed: Dec. 7, 2018
(86) PCT No.: PCT/US2018/064564

§ 371 Date: Apr. 7, 2021

(51) Int. Cl. H04L 9/32; H04L 9/30

(52) U.S. Cl. CPC H04L 9/3247; H04L 9/30

(57) ABSTRACT

A method of operating a service provider server and a computing device to provide anonymous service access. For the service provider server, the method comprises: receiving a service message from a computing device; and determining whether to send a service response message, and if so sending a service response message. The service message includes a pseudonym associated with the computing device, service data and a signature on the pseudonym generated by either the service provider server or an identity manager. The service response message is broadcast by the service provider server or transmitted to the identity manager.

### BACKGROUND

Computing services may be provided remotely to uses by a service provider server. One example is a data log service where a service provider collects and analyses logs for users or companies and alerts those users or companies if log data reveals anything unusual or noteworthy. Log data may comprise status information for the computing device or applications operating on the computing device.

### BRIEF INTRODUCTION OF THE DRAWINGS

Examples of the disclosure are further described hereinafter with reference to the accompanying drawings, in which:

FIG. 1 illustrates an example of service access system;

FIG. 2 is a flowchart for a method of operating a user computing device in a service access system;

FIG. 3 is a flowchart for a method of operating a service provider server in a service access system;

FIG. 4 illustrates an example method of operating a service access system;

FIG. 5 illustrates another example of service access system;

FIG. 6 illustrates another example method of operating a service access system;

FIG. 7 illustrates a further example method of operating a service access system;

FIG. 8 illustrates a yet further example method of operating a service access system;

FIG. 9 illustrates an example of a user computing device forming part of a service access system;

FIG. 10 illustrates an example of a service provider server forming part of a service access system; and

FIG. 11 illustrates an example of an identity manager forming part of a service access system.

### DETAILED DESCRIPTION

Examples presented below concern, in particular, access to a data log service whereby a computing device owned or operated by a user transmits data logs to a server of a service provider. The service provider server may store the data logs and analyse the content of the data logs. The logs may contain information about the computing device, or, for instance, an application operating on that computing device. The computing device may comprise any fixed or portable computing device, for instance a desktop computing, laptop, mobile device (for instance, a smart phone or tablet computer), a peripheral device (for instance, a printer), an Internet of Things (IoT) device, or a smart appliance. More generally, the computing device may comprise any device, whether operated by a human user or otherwise, which is capable of communicating with a server for exchanging information and accessing services. The service provider server may analyse log data collected from that computing device or may collate that log data with that from other computing devices, which may be associated with different users. If the service provider notes that the log data or analysis upon the log data reveals anything unusual or noteworthy, it may return a message to the or each computing device affected. This form of service access system is one form of remotely provided service whereby service messages are transmitted from computing devices to a service provider server and information is transmitted from the service provider server to the computing device in a service response message. The examples presented below apply equally to other forms of remotely provided service.

User privacy, particularly maintaining a private identity for the user or a computing device operated by a user, is a concern for many remotely provided services. For the specific example of a data log service, some users may feel that transmitting log data to a service provider results in an unacceptable loss of privacy. In certain examples, for access to a data log service to provide valuable data analytics frequently the assumption is that forfeiting privacy is a side effect. This may impede access to and uptake of data log services and the analytics they provide. Additionally, providing log data anonymously to the service provider may result in the service provider being unable to inform the user of unusual or noteworthy conditions revealed by the collected log data. For many data log systems, anonymisation may be achieved at the expense of removing or avoiding altogether the collection of data that may be personally identifiable, such as user name fields. In some instances, a machine identifier is created and used instead of a persistent identity for the user or the computing device, however this does not prevent data log files being linked to the originating computing device.

Certain examples of the present disclosure allow a computing device operated by a user to anonymously access a service operated by a service provider while preserving the ability of the service provider to transmit information in return to the computing device. As discussed in relation to the specific examples set out below, this anonymous service access is implemented using a pseudonym for the user or their computing device. The service provider may be unable to link the pseudonym to the persistent identity of the user, yet retain the ability to associate different data logs with the same pseudonym and to transmit messages in response to the corresponding computing device. That is, the service provider may not know to whom each set of logs belongs, whilst maintaining the functionality of a data log service to alert the user where the content of the log files or analysis thereon indicates unusual or noteworthy information.

As set out in the examples below, the service provider is able to transmit information in reply to the user's computing device either by broadcasting a message to the anonymised user, which can be read by the user's computing device, or by transmitting the message through an intermediary, for instance an identity manager, who is aware of the correlation between a pseudonym and a persistent identity for the user. The information transmitted by the service provider may be encrypted so that the owner of the pseudonym, but not another party intercepting the transmitted information, is able to decrypt the message. The user is able to choose how to respond to information received from the service provider: one option is for the user to voluntarily reveal part or the whole of their identity to the service provider, in order to provide further information to the service provider, or to contact the service provider for help.

The use of a pseudonym hides the true identity of the user from the service provider. According to certain examples, the pseudonym may be signed by the service provider or an identity manager such that the signed pseudonym indicates to the service provider that the user is one of a group of users authorised to submit their log files to the service provider for analysis. The service provider then collects and analyses the log files, which are linked to the pseudonym, without the service provider knowing the real or persistent identity associated with the pseudonym.

As noted above, the user may voluntarily relinquish their anonymity, for instance to seek help from the service provider. They may subsequently adopt a different pseudonym for the submission of logs from that point onwards. Furthermore, the user may submit different log files under different pseudonyms, or change pseudonyms over time (or change pseudonyms according to their defined policy). In addition to providing anonymity, certain examples of the disclosure discussed below provide the users with the additional privacy property of unlinkability. Unlinkability means the service provider cannot link two pseudonyms to the same user, and so provides further privacy to the user by mitigating against malicious attempts to infer the persistent identity associated with a user by relating data to anonymised users. The information transmitted by the service provider may signal there is something significant in the log files and request some of the files be linked to better aid analysis. The user may then be able to opt to degrade their privacy in order to aid better analysis of their files by the service provider.

### Individual Access to a Data Log Service

According to an example of the disclosure, individual users of a service, for instance a data log service, directly communicate with a service provider server. For a data log service, computing devices associated with users may directly transmit service messages to a service provider server and receive service response messages in reply following analysis of the data logs by the service provider server.

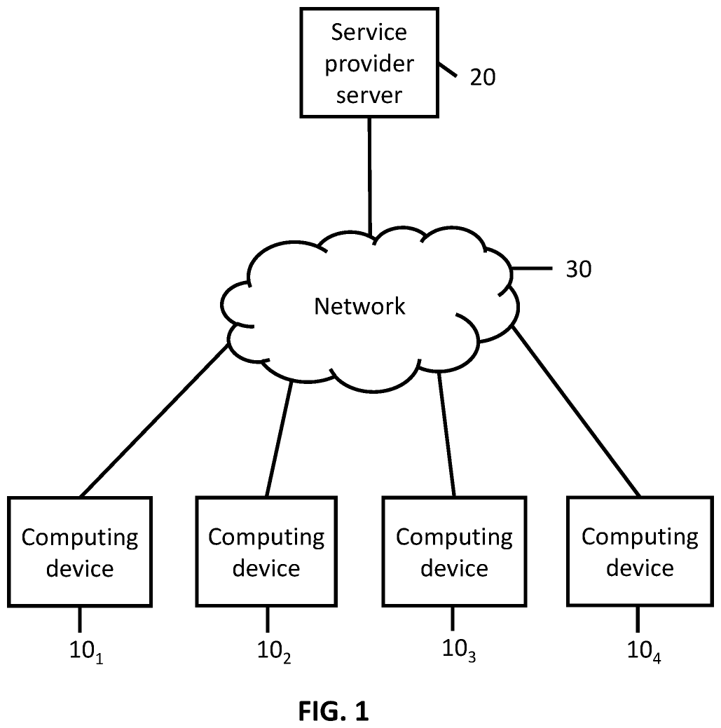

Referring to FIG. 1, this illustrate a plurality of computing devices 10 (10₁, 10₂ etc.) communicating with a service provider server 20 across a network 30. Each computing device 10 may be associated with a different user, or a user may have multiple associated computing devices. Each computing device 10 may communicate with the service provider 20 by transmitting a data log in the form of a service message. The service provider 20 receives the data logs, analyses their contents and may transmit a service response message to the or each affected computing device if an unusual or noteworthy condition is detected. The service response message may be broadcast by the service provider server 20, as discussed below. The service response message may indicate the appropriate action to be taken.

According to the present example, individual users wish to keep their identity private such that the service provider server 20 is unable to link the logs to the individual computing device 10. In order to maintain the user's privacy, the network 30 may comprise an anonymous communication network, such as a MixNet network as described in Chaum, D. L. (1981): “Untraceable Electronic Mail, Return Addresses, and Digital Pseudonyms”, Communications of the ACM, 24(2), p 84-90. A further example of an anonymous communication network is an onion router as described in Syverson, P., Dingledine, R., & Mathewson, N. (2004): “TOR: The Second Generation Onion Router”, Usenix Security, and further described in Reed, M. G., Syverson, P. F., & Goldschlag, D. M. (1998): “Anonymous Connections and Onion Routing”, IEEE Journal on Selected areas in Communications, 16(4), p 482-494. An anonymous communication network allows two parties to communicate without either party knowing the location or identity of the other party. As will be described in detail, pseudonyms are used to protect, at the application layer, the identity of users and their associated computing devices. Without using an anonymous network, an attacker would be able to associate pseudonyms, even when they change, with a single IP address, which would risk undermining the privacy afforded by a pseudonym.

In addition to the use of an anonymous network, examples of the present disclosure make use of a pseudonym such that a computing device 10 may communicate with the service provider server 20. The authority of the computing device 10 to participate in the service provided by the service provider server 20 is indicated by a signature applied to the pseudonym.

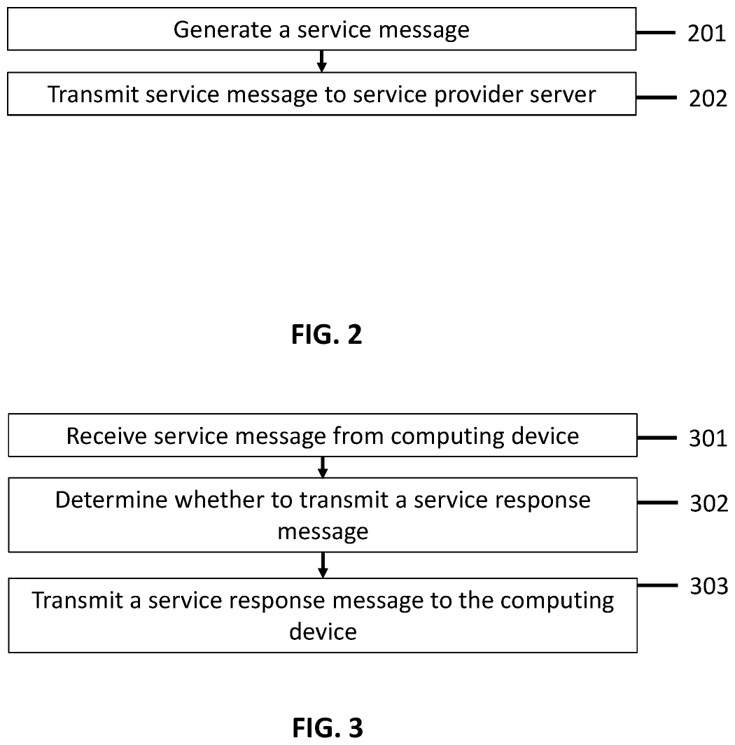

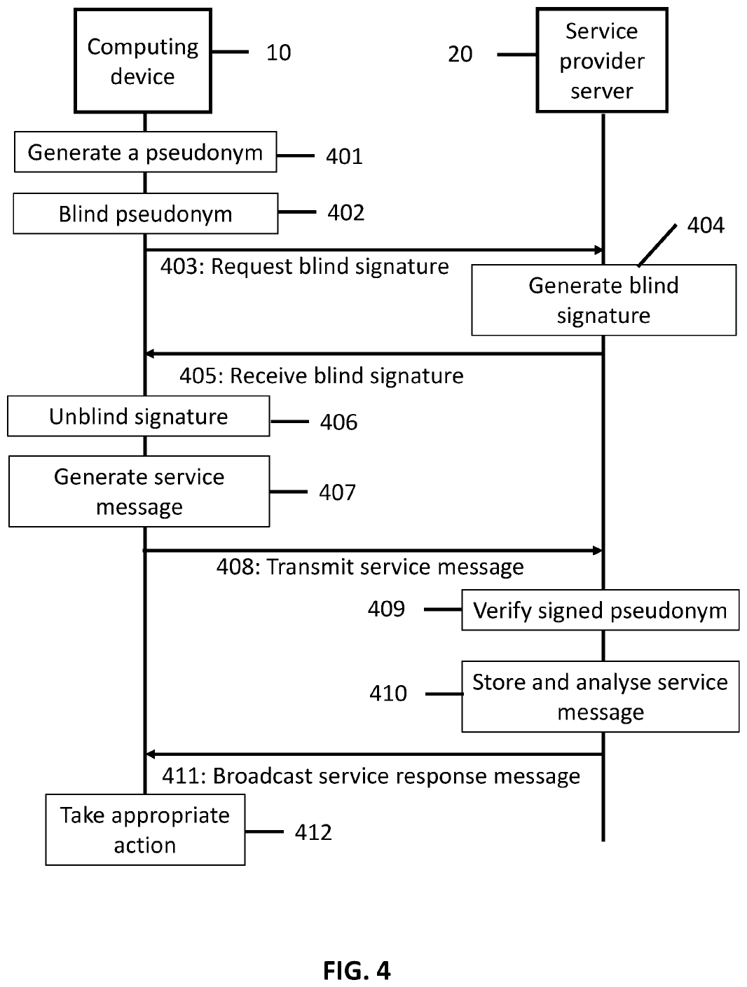

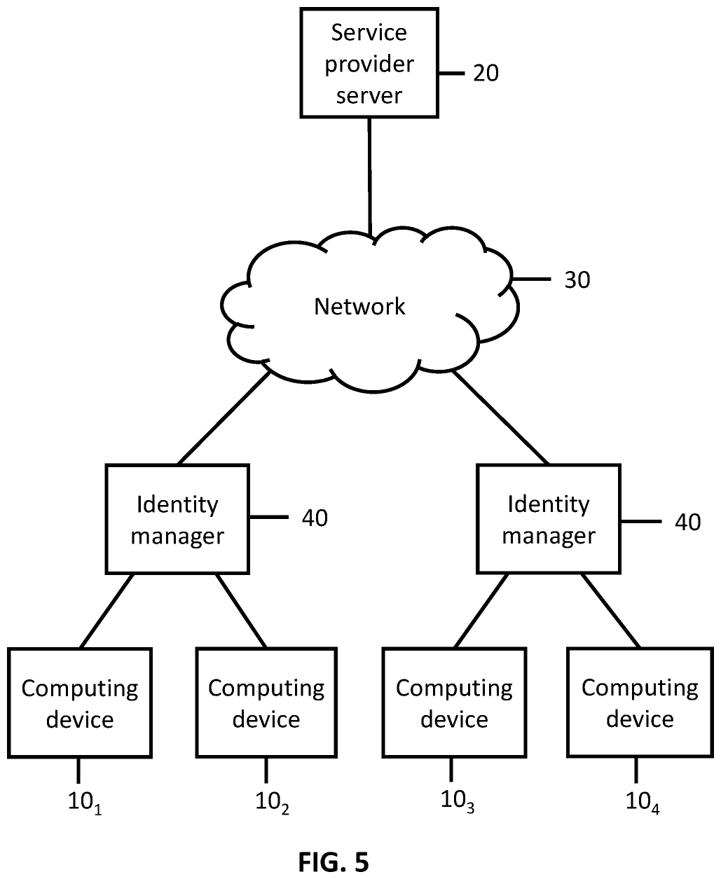

Referring to FIG. 2, this is a flowchart for a method of operating a user computing device 10 in a service access system in accordance with an example of the disclosure. At 201 the computing device 10 generates a service message. This may comprise service data, particularly where the service access system is a data log service. The service message may further comprise a pseudonym associated with the computing device 10 and a signature applied to the pseudonym by the service provider server of an identity manager (as discussed below in connection with FIGS. 5 to 8). The generation of the pseudonym and the obtaining of a signature applied to the pseudonym will be described below in connection with FIGS. 4 and 6 to 8.

The signed pseudonym indicates to the service provider server 20 that the computing device is authorised to access the service without the service provider server 20 being able to link the pseudonym to the computing device 10.

At 202 the computing device 10 transmits the service message to the service provider server 20.

Subsequently, the computing device 10 may receive a service response message from the service provider server 20. The service response message may be broadcast by the service provider server 20 so that it may be received by the computing device 10. However, in accordance with certain indirect access scenarios discussed below the service response message may not be received by the computing device 10, rather it may be processed by an identity manager.

It will be understood that the service response message may not be directly in response to the service message. Service response messages may be received periodically or in the event that analysis of the service messages indicates a need for the service provider server 20 to transmit a service response message. Service messages may be generated and transmitted periodically, or as needed, and multiple service messages may be transmitted before the receipt of a service response message.

Referring to FIG. 3, this is a flowchart for a method of operating a service provider server 20 in a service access system in accordance with an example of the disclosure. The method illustrated in FIG. 2 is the counterpart of the method illustrated in FIG. 2 and so will be more briefly described.

At 301 the service provider server 20 receives a service message from a computing device 10. The service message may take the same form as noted above in connection with 201.

At 302 the service provider server 20 determines whether to send a service response message. For the example of a data log service, the determination may comprise analysis performed on data logs received from the computing device 10 in isolation or in combination with data logs received from other computing devices.

If it is determined to transmit a service response message, then at 303 the service provider server 20 transmits the service response message which may be by broadcasting the service response message, as noted above, or by transmission to an identity manager.

Referring now to FIG. 4, this illustrates a method of operating a service access system in accordance with an example of the disclosure. Specifically, FIG. 4 illustrates the operation of a single computing device 10 communicating with a service provider server 20, for instance in a data log service.

At 401 the user generates a pseudonym. The pseudonym does not have to be certified or registered, so long as the pseudonym leaves the owner with some secret information such that possession of this secret information proves ownership of the pseudonym. One solution is for the pseudonym generation be a digital signature key generation, keeping the (private) signing key as the secret information and using the public key as the pseudonym. Examples of the present disclosure are not limited to any particular key generation technique.

At 402 and 403 the computing device 10 requests a blind signature from the service provider server 20 on their pseudonym. Blind signatures may take the form initially introduced in 1983 by Chaum, as described in Chaum, D. (1983), “Blind Signatures for Untraceable Payments”, Advances in Cryptology, p 199-203, Springer, Boston, Mass. Specifically, a blind signature is a form of digital signature in which the content of a message (here, the pseudonym) is blinded (that is, disguised or obfuscated) prior to generating the signature. The pseudonym is blinded from the perspective of the service provider, who does not learn information about the unblinded pseudonym which will later be used communicate service messages. The blinding may later be reversed (by the computing device that performed the blinding) for the signed pseudonym, resulting in a signature on to the original (unblinded) pseudonym. A property of blind signatures is that the signer (here, the service provider server) is unable to link the blinded message it signs (here, the blinded pseudonym) to a later un-blinded version of the signature (here, the signed, un-blinded pseudonym) that it is later called upon to verify. More generally, anyone in possession of the service provider server's pubic key is able to verify the signature. Blind signatures may be implemented using a number of different public key signing schemes, for instance schemes based on RSA or ECC, but the present disclosure is not limited to any particular blind signature scheme.

At 402 the computing device 10 blinds the generated pseudonym and at 403 requests a signature on the blinded pseudonym from the service provider server 20 by transmitting the blinded pseudonym to the service provider server. “Blinding” may comprise combining the pseudonym in some way with a random “blinding factor”.

At 404 the service provider server 20 signs the blinded pseudonym, which as noted above may be through any public key signing scheme. That is, the service provider server 20 signs the blind pseudonym using its secret key, such that the signature may be later verified by any party through the public key of the service provider server 20. At 405 the service provider server 20 returns the blind signature to the computing device 10.

At 406 the computing device can “unblind” the signature to reveal a valid signature from the service provider server 20 on their pseudonym without the service provider server at any point learning the pseudonym through the signature process. This provides the property of “unlinkability” discussed above, in that the service provider server 20 cannot later link a user or their computing device which provided the blind pseudonym to their unblind pseudonym (which as noted above is included in service messages transmitted from the computing device 10 to the service provider server 20). However, by providing a signature from the service provider server 20 on the unblind pseudonym the computing device 10 is able to demonstrate to the service provider server 20 that it is an authorised user for that service. Any blind signature scheme may be used, such as the scheme proposed by Okamoto, T. (2006, March), “Efficient Blind and Partially Blind Signatures Without Random Oracles”, Theory of Cryptography Conference, p 80-99, Springer, Berlin, Heidelberg. An alternative scheme is proposed by Chaum (1983), referenced above.

The process of requesting and receiving a blind signature may vary significantly from the above described process. For instance, the request at 403 for a blind signature may be signed by the user or their computing device using a secret key for which there is a public key known to be associated with that user. This signature applied to the request allows the service provider server to have confidence that the request comes from an authorised user (who is authorised to send their log files) but need not be private.

At 407 the computing device 10 generates a service message. Service message generation at 412 corresponds to service message generation at 201 of FIG. 2. As discussed above, the service message may comprise service data in the form of log files (for the example of a data log service), along with their (unblind) pseudonym and the service provider server's signature on their (un-blinded) pseudonym. The service message may further include a signature for all the information in the service message, the signature being generated using the secret key corresponding to the computing device's pseudonym. The information sent is shown in Table 1 shown below.

TABLE 1
Service message content

| | |
|---|---|
| nym | The pseudonym for the computing device. |
| | For instance, the public key of a digital |
| | signature algorithm. |
| Sig_{SP}(nym) | The signature produced by the service |
| | provider server (SP) on the pseudonym nym. |
| logs | The service data. For instance, log files the |
| | user wishes to send to the SP. |
| Sig_{nym}(nym, | The signature on all previous elements, |
| Sig_{SP}(nym), logs) | generated using the secret information |
| | corresponding to the pseudonym nym. |

Providing the pseudonym within the service message allows the recipient service provider server 20 to verify whether the signature on the pseudonym generated by the service provider server, Sig_{SP}(nym), is correct. The service provider server 20 has previously received and signed the blinded pseudonym and so without the pseudonym itself the service provider server 20 is unable to perform this verification and confirm that the computing device 10 is entitled to access the service. Additionally, including the pseudonym allows the receiver to verify the unblinded signature on the pseudonym to verify the signature on the other elements of the service message. This guards against an attacker seeking to make use of a previously observed token. This assurance is achieved by the computing device 10 signing the service message, Sig_{nym}(nym, Sig_{SP}(nym), logs), to prove that they are the owner of the pseudonym (because the pseudonym is the public key used to verify the signature generated using the private key kept secret by the computing device 10). Additionally, including the pseudonym enables the service provider server 20 to encrypt the service response message.

At 408 the generated service message is transmitted by the computing device 10 to the service provider server 20. Service message transmission at 408 corresponds to service message transmission at 202 of FIG. 2 and at 301 of FIG. 3.

As a further option, while the information in service message may be transmitted unencrypted (particularly in the event that there is a point to point secure, anonymous connection between the computing device 10 and the service provider server 20), the service message may be encrypted using the service provider server's public key.

Encryption of the service message may be desirable if the user wishes to hide either (i) their log files or (ii) their pseudonym to prevent attackers either from (i) learning all the information in their log files or (ii) searching for messages at a later date that are targeted at the pseudonym.

At 409 the service provider may verify the signature applied to the pseudonym, Sig_{SP}(nym), according to the pseudonym, nym, included in the service message. If the whole service message is signed, Sig_{nym}(nym, Sig_{SP}(nym), logs), the service provider server 20 may also verify that the service message has not been altered since being generated by the computing device.

If the or each signature is valid, at 410 the service provider server 20 stores and analyses the log files. The storage and analysis at 410 corresponds to the storage and analysis at 302 of FIG. 3. If the analysis at 410 indicates anything unusual or noteworthy then at 411 the service provider server 20 broadcasts a service response message to all computing devices 10 in the service access system. The service response message broadcast at 411 corresponds to the service response message broadcast at 303 of FIG. 3. A broadcast service response message may be used when, as for the present example, the service provider server 20 does not know which computing device 10 (from those authorised to access the service, the group of which may be known to the service provider server) corresponds to the pseudonym connected with the log files triggering the service response message. Any suitable broadcast communication scheme may be used. One suitable example is to use a blockchain to broadcast the information to all computing devices. The service response message may include any combination of the message portions shown in Table 2 so long as it includes the message to be transmitted to the designated computing device and some way of identifying the intended recipient. The service response message may be of the following form:

TABLE 2
Service response message content

| | |
|---|---|
| h = Hash(nym) | A cryptographic hash of the user's |
| | pseudonym |
| C = Enc_{nym}(message) | The encrypted message, encrypted using |
| | the public information of the user's |
| | pseudonym. |
| Sig_{SP}(h, C) | The SP's signature on the hash digest and |
| | the ciphertext. |

The cryptographic hash of the user's pseudonym identifies the intended recipient of the broadcast service response message as the computing device which is associated with the pseudonym will be able to generate and monitor for the same cryptographic hash. Any suitable cryptographic hash may be used. Alternatively, the pseudonym itself may be transmitted to identify the intended recipient. Transmitting a hash of the pseudonym may minimise the amount of data to be transmitted, especially where the pseudonym comprises a long public key associated with the computing device, which may be particularly desirable in the event that a blockchain is used to broadcast the service response message. A further option is to instead include some value (for instance, a nonce) which is sent to the service provider server 20 by the computing device 10 (for instance, in the service message) and serves to identify that the service response message is intended for that computing device 10. The nonce may change periodically; optionally changing for every service message transmitted.

Where a hash of the computing device's pseudonym is used then in some circumstances information at least relating to the number and timing of service response messages may be accessible to an attacker. To mitigate against this, according to a further example the hash may be expanded by first combining the pseudonym with information which changes, for instance the date or time, or the block number in the event that a blockchain is used as the broadcast mechanism. Using time (for example, accurate to the hour, minute or second) instead of date provides finer resolution and minimises the chance of the same hash being used multiple times, at the expense of increasing the number of hashes to be computed. If a network 30 is used which may experience time delays then the computing device 10 may generate and keep track of multiple hashes and observe for service response messages in the broadcast including any of those hashes.

The message from the service provider server 20 to the computing device may be encrypted using the pseudonym, where the pseudonym comprises a public part of a public/private key pair and the private key is kept secret by the computing device associated with the pseudonym. In some examples the message may be transmitted unencrypted.

The service response message may include the signature of the service provider server 20 on the remaining contents of the service response message in order to verify that the received message has not been altered.

In order to prevent attackers who know the pseudonyms of some computing devices, (for instance, if the attacker has witnessed the pseudonym when the log files were transmitted to the service provider server in the service message) the service provider server 20 may broadcast a dummy message or multiple dummy messages so that attackers cannot necessarily conclude that there is an issue with a pseudonym's logs just because a message was broadcast to them. That is, an attacker may observe that the computing device receives five messages a day, but does not know how many, once decrypted, signify that all is well.

The computing device 10 may continuously or periodically check the broadcast channel for service response messages sent to them. To do so, the computing device 10 may compute the cryptographic hash of their pseudonym and monitor for this in any message broadcast. If so, then at 412 the computing device may verify that the service response message came from the service provider server 20, if the message is signed by the service provider server. If the message is encrypted then the computing device may decrypt the ciphertext C and read the message meant for them, and take the appropriate action.

On receipt of a service response message the computing device 10 may selectively de-anonymise themselves by revealing their identity to the service provider server to receive help or advice. Furthermore, this may be requested by the service provider server 20 in the service response message. For instance, the service provider server may request identity information to link different log files in order to aid analysis. If the computing device 10 does opt to de-anonymise themselves, they may subsequently generate and use a new pseudonym according to the process of FIG. 4 and re-enter the system as a new user. This may, however, affect the analysis of their logs as the previous logs generated under their previous pseudonym would be un-linkable to those generated under the current pseudonym.

### Indirect Access to a Data Log Service

The examples set out above concern individual computing devices 10 communicating directly with a service provider server 20. However, a remote service may be provided in a context where there is indirect access, as illustrated in FIG. 5. This may be particularly applicable to an enterprise setting, where an identity manager 40, such as a company administrator or IT manager manages users' computing devices 10 and is responsible for sending data logs to the service provider server 20 either directly or for administering the process. FIG. 5 illustrates an example where computing devices 10₁, 10₂ are associated with a first identity manager 40₁ and computing devices 10₃, 10₄ are associated with a first identity manager 40₂. This may comprise different enterprises or organisations, or different parts of a single enterprise. While the examples may be presented in the context of enterprise access to a data log service, they may be equally applicable in a wholly independent service where a separate identity manger role is implemented.

In the examples discussed below service messages and (in some cases service response messages) are described as being communicated directly between the computing device 10 and the service provider server 20. Such messages may entirely bypass the identity manager, or the identity manager may simply forward some or all of those messages.

Differing to the system of FIG. 1, as there is now at least one entity (the identity manager or IT manager) between the computing devices 10 and the service provider server, there are four different options for anonymising the identity of the computing device:

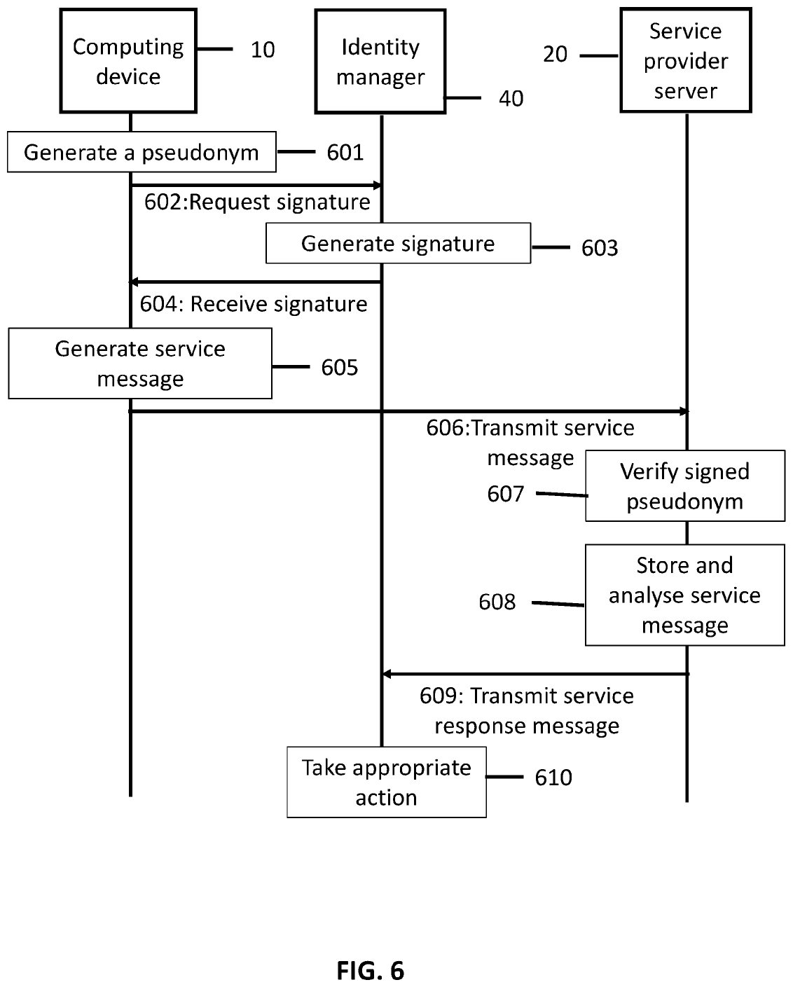

According to a first option, the identity of the computing device is known to the identity manager but not to the service provider server. The service provider server knows which identity manager the computing device is associated with. A method of providing this anonymity is illustrated in FIG. 6.

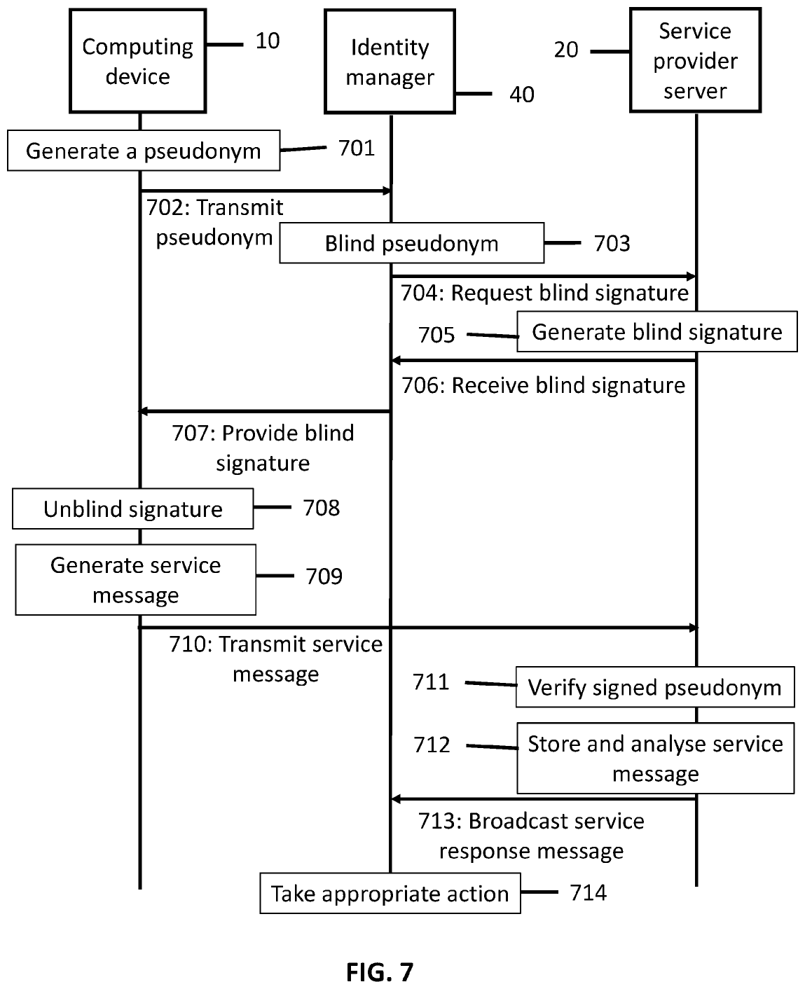

According to a second option, the identity of the computing device is known to the identity manager but not to the service provider server. The service provider server does not know which identity manager the computing device is associated with. A method of providing this anonymity is illustrated in FIG. 7.

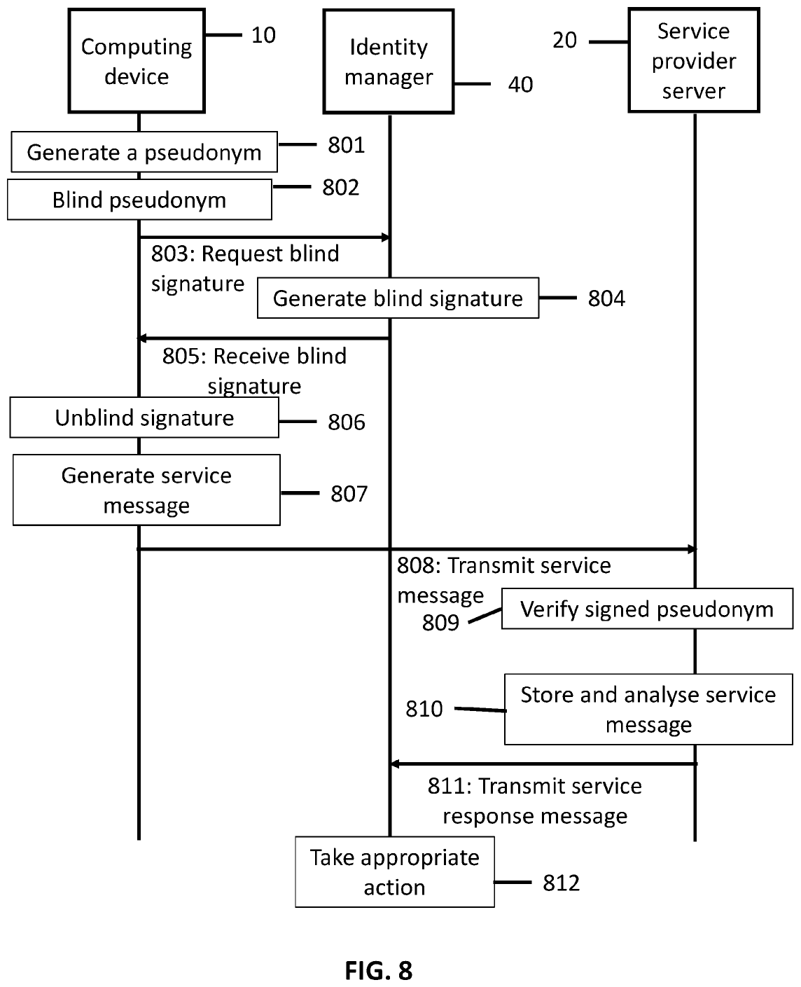

According to a third option, the identity of the computing device is anonymous and unknown to both the identity manager and the service provider server. The service provider server knows which identity manager the computing device is associated with. A method of providing this anonymity is illustrated in FIG. 8.

According to a fourth option, the identity of the computing device is anonymous and unknown to both the identity manager and the service provider server. The service provider server does not know which identity manager the computing device is associated with. In substance this corresponds to the individual access scenario described in connection with FIG. 4, and so will not be further described.

According to certain of the four options set out above, it may be that the pseudonym for a computing device 10 is in fact signed by the associated identity manager 40, and not the service provider server 20. With reference to FIGS. 2 and 3, in that situation the content of the service message may differ in that the signed pseudonym may be signed by the identity manager 40. The service provider server 20 accepts the provision of this signed pseudonym as authorisation to access the service it provides. This may rely on a trust relationship being established between the service provider server 20 and the identity manager 40. A trust relationship may result from the nature of the service provided, for instance where the service is paid for by an enterprise on behalf of their users, and facilitated by an IT manager, who as discussed above may act as the identity manager.

According to the four options set out above, in some cases the service provider server 20 knows the identity manager 40 with whom the computing device is associated. If the identity of the computing device is also known to the identity manager, then in substitution to the broadcast of the service response message described above in connection with FIGS. 2 and 3, the service response message may be communicated to the computing device via the identity manager 40 rather than being broadcast.

Turning to FIG. 6, the first indirect access option (the identity of the computing device is known to the identity manager but not to the service provider server, and the service provider server knows which identity manager the computing device is associated with) will now be described. Where the process is the same as that described above in connection with FIG. 4 then this will be briefly noted, and the differences described in detail.

At 601 the computing device generates a pseudonym. This may be the same as described above in connection with part 401 of FIG. 4. Alternatively (and not illustrated), as the identity of the computing device is known to the identity manager 40, the identity manager 40 may generate and distribute pseudonyms to its associated computing devices 10.

At 602 the computing device requests a signature on the pseudonym from the identity manager 40. As the identity of the computing device 10 is known to the identity manager 40 there may be no blinding and unblinding process as described in parts 402 to 406 of Figure. Rather, the request 602 may comprise providing the cleartext pseudonym to the identity manager 40 (unless this is already in the possession of the identity manager 40). At 603 the identity manager 40 generates a signature on the pseudonym, and at 604 this is provided to the computing device 10.

Once in possession of the signature from the identity manager 40, the process of generating a service message, transmitting the service message to the service provider server 20 and the operations performed by the service provider server 20 at parts 605 to 608 correspond generally to the process of parts 407 to 410 of FIG. 4. The process differs in that the service provider server 20 accepts the signature of the identity manager 40 in place of its own as confirmation that the computing device 10 is authorised to access the service. The computing device 10 is anonymous to the service provider server 10 because at no point has its true identity been revealed to the service provider server 10: all communications between the computing device 10 and the service provider server 20 use the pseudonym.

If the analysis at 608 reveals anything that should be reported to the computing device 10 then at 609 the service provider server 20 transmits a service response message to the identity manager, which may take the same form set out above in Table 2. At 610 on receipt of the service response message the identity manager 40 may take the appropriate action, which may as appropriate include forwarding the response message to the computing device 10 (not illustrated) which may respond in similar ways to those described above in connection with part 412 of FIG. 4. For instance, the identity manager 40 may communicate directly with the service provider server 20 and may reveal the real identity of the computing device 10. In an alternative, if the computing devices 10 are able to directly receive broadcast messages from the service provider server 20 then the same broadcast process described in connection with part 411 of FIG. 4 may be used.

Turning to FIG. 7, the second indirect access option differs from the first in that additionally the service provider server 20 does not know which identity manager 40 the computing device 10 is associated with. Where the process is the same as that described above in connection with FIG. 4 or 6 then this will be briefly noted, and the differences described in detail.

At 701 and 702 the computing device 10 generates a pseudonym and transmits it to the identity manager. As described above in connection with part 601 of FIG. 6, in an alternative (not illustrated) the identity manager 10 may generate and distribute the pseudonyms for each associated computing device 10.

As the identity manager 40 wishes for the service provider server 20 to not know which identity manager 40 a given computing device is associated with, then as for FIG. 4 a process of obtaining a blind signature from the service provider server 20 is followed. The process of parts 703 to 708 generally correspond to the process of parts 402 to 406 of FIG. 4 except that as the identity manager 40 knows the identity of the computing device 10, it may be the identity manager 40 which performs the blinding (703), requests the blind signature (704), and receives the blind signature (706). The identity manager 40 may forward the blind signature to the computing device 10 at 707, and the computing device 10 performs the unblinding at 708. In a further alternative (not illustrated) the identity manager may also perform the unblinding and provide the computing device 10 with the unblind signature.

The process from generating a service message at 709 through to broadcasting a service response message at 713 may be same as for parts 407 to 411 of FIG. 4. However, differing from the process of FIG. 4 it may be that the computing device 10 does not or cannot receive the broadcast and so it is received instead by the identity manager 40 (who knows the pseudonym). The identity manager 40 may then take the appropriate action at 714 in the same way as described above in connection with part 610 of FIG. 6.

Turning to FIG. 8, the third indirect access option differs from the first in that the computing device is anonymous and unknown to both the identity manager and the service provider server. Where the process is the same as that described above in connection with FIG. 4 or 6 then this will be briefly noted, and the differences described in detail.

As the computing device 10 is anonymous to the identity manager 40 then it generates its own pseudonym and receive a blind signature from the identity manager 40. The process of parts 801 to 806 is generally the same as that of parts 401 to 406 of FIG. 4 except that it is the identity manager 40 assuming the signatory role instead of the service provider server 20.

The process of generating and transmitting service messages through to transmitting a service response message and taking action, from parts 807 to 812, may be same as for parts 506 to 510 of FIG. 6.

In an indirect access scenario, such as in an enterprise setting, unlinkability can be achieved by allowing either the identity manager 40 or the computing devices 10 to generate and use different pseudonyms according to different log files, time periods, or groups (according to some policy defined by the enterprise). The service provider server may use the broadcast service response message or the service response message communicated through the identity manager to request linkability of some files, and as described above in connection with the individual access scenario. As before, the SP is unable to link the files without the help and explicit consent of the IT manager/user.

For the first and third indirect access scenarios of FIGS. 6 and 8, where service response messages are not broadcast, rather they are transmitted directly to the identity manager then the pseudonym may be used in place of a hash in order to identity the associated computing device 10. In some circumstances the use of an identifying nonce may not be appropriate in the event that the identity manager is not able to learn all of the service data transmitted from the computing device 10 to the service provider server 20.

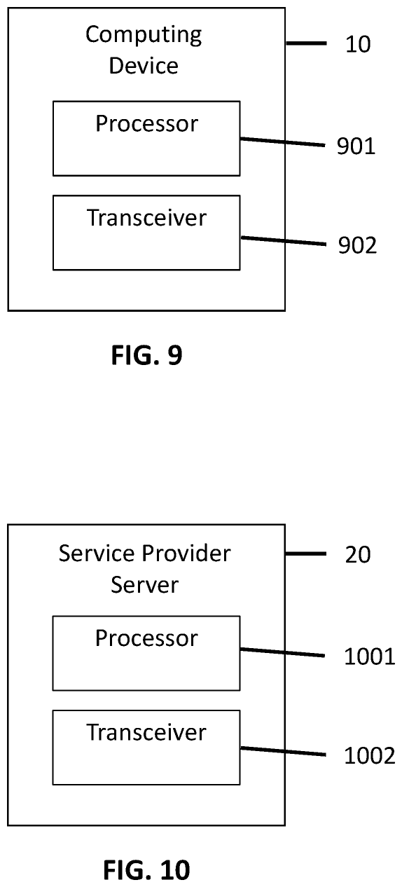

Referring now to FIG. 9, a computing device 10 in accordance with an example of the disclosure is illustrated. The computing device 10 comprises a processor 901 and a transceiver 902. The processor 901 acts in accordance with the examples set out above, including as appropriate being responsible for generating a pseudonym, performing blinding and unblinding operations, generating service messages and responding appropriately to a service response message. The transceiver 902 is responsible for communicating messages with the service provider 20 and the identity manager 40, as appropriate for each of the examples set out above.

Referring now to FIG. 10, a service provider server 20 in accordance with an example of the disclosure is illustrated. The service provider server 20 comprises a processor 1001 and a transceiver 1002. The processor 1001 acts in accordance with the examples set out above, including as appropriate being responsible for generating blind signatures, verifying signed pseudonyms, storing and analysing service messages and generating service response messages. The transceiver 1002 is responsible for communicating messages with the computing device 10 and the identity manager 40, as appropriate for each of the examples set out above.

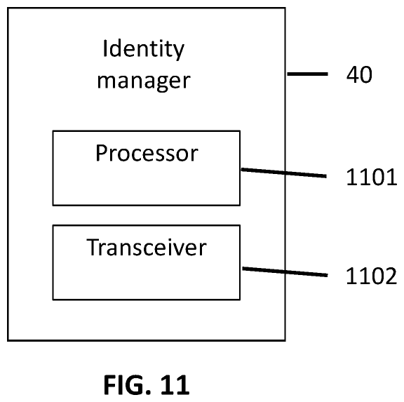

Referring now to FIG. 11, an identity manager 40 in accordance with an example of the disclosure is illustrated. The identity manager 40 comprises a processor 1101 and a transceiver 1102. The processor 1101 acts in accordance with the examples set out above, including as appropriate being responsible for generating a signature (blind or unblind) and responding appropriately to a service response message. The transceiver 1102 is responsible for communicating messages with the computing device 10 and the identity manager 40, as appropriate for each of the examples set out above.

The examples of the present disclosure set out above lend themselves to numerous different implementation scenarios. Focusing on the situation in which the remote access service is a data logging service, the role of the service provider server may be provided by a first organisation which offers data logging services on a commercial basis to individual consumers, enterprises and other organisations alike. Those customers may have particular reasons to wish to obscure their identity from the service provider server to prevent that party from learning information about them or their business practices.

The role of the service provider may be provided as a remote service. As an alternative implementation option, the service provider server may be deployed physically or logically as part of the private network of a customer, where dedicated hardware is used within the customer organisation to collect and process the logs. Here, the scheme functions similarly to the service model.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings), may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants which fall within the scope of the claims.

1. A method of operating a service provider server providing anonymous service access, the method comprising:
receiving a service message from a computing device; and
determining whether to send a service response message, and if so sending a service response message;
wherein the service message includes a pseudonym associated with the computing device, service data and a signature on the pseudonym generated by either the service provider server or an identity manager; and
wherein the service response message is broadcast by the service provider server or transmitted to the identity manager.

2. The method of claim 1, wherein the signature on the pseudonym indicates to the service provider server that the computing device can access the service without the service provider server being able to link the pseudonym to the computing device.

3. The method of claim 1, wherein the pseudonym comprises a public encryption key associated with the computing device;
wherein the service message further includes a signature on the remaining parts of the service message generated using a private encryption key corresponding to the public encryption key pseudonym; and
wherein the method further comprises the service provider server using the pseudonym to verify that the signature was generated by an owner of the pseudonym.

4. The method of claim 1, further comprising generating the service response message comprising service response data and the pseudonym or a cryptographic hash of the pseudonym.

5. The method of claim 4, wherein the method further comprises generating a signature on the remaining parts of the service response message using a private encryption key associated with the service provider server, and incorporating the signature into the service response message.

6. The method of claim 1, wherein determining whether to send a service response message comprises:
storing and analysing service data in the service message to detect unusual or noteworthy conditions in the service data.

7. A computing device comprising:
a processor to generate a service message to be transmitted to a service provider server; and
a transceiver to transmit the service message to the service provider server;
wherein the service message includes a pseudonym associated with the computing device, service data and a signature on the pseudonym generated by either the service provider server or an identity manager.

8. The computing device of claim 7, wherein the transceiver is operable to receive a service response message from the service provider server; and
wherein the service response message is broadcast by the service provider server or received via the identity manager.

9. The computing device of claim 7, wherein the signature on the pseudonym indicates to the service provider server that the computing device is permitted to access the service without the service provider server being able to link the pseudonym to the computing device.

10. The computing device of claim 7, wherein the processor is operable to generate the pseudonym, comprising a public encryption key, and a corresponding private encryption key, or wherein the transceiver is operable to receive a public encryption key pseudonym and a private encryption key from the identity manager; and
wherein the process is operable to generate a signature on the remaining parts of the service message generated using the private encryption key and incorporate the signature into the service message.

11. The computing device of claim 7, wherein the signature on the pseudonym is obtained by the processor being operable to perform one of:
blinding the pseudonym, controlling the transceiver to request a blind signature from either the service provider server or the identity manager, controlling the transceiver to receive the blind signature, and unblinding the signature;
controlling the transceiver to request a signature from the identity manager, and controlling the transceiver to receive the signature; and
controlling the transceiver to provide the pseudonym to the identity manager, controlling the transceiver to receive a blind signature, and unblinding the signature.

12. The computing device of claim 8, wherein the service response message comprises service response data and the pseudonym or a cryptographic hash of the pseudonym.

13. The computing device of claim 12, wherein if the service response message is broadcast, the processor is operable to control the transceiver to receive broadcast service messages and further operable to detect if a received service response message includes the pseudonym or the cryptographic hash of the pseudonym for that computing device.

14. The computing device of claim 12, wherein the processor is operable on receipt of a service response message to determine whether to de-anonymise the computing device, and if so to transmit a persistent identity of the computing device to the service provider server.

15. A non-transitory machine-readable storage medium encoded with instructions executable by a processor of a computing device, the machine-readable storage medium comprising instructions to:
generate a service message to be transmitted to a service provider server; and
control a transceiver of the computing device to transmit the service message to the service provider server and to receive a service response message from the service provider server;
wherein the service message includes a pseudonym associated with the computing device, service data and a signature on the pseudonym generated either the service provider server or an identity manager; and
wherein the service response message is broadcast by the service provider server or received via the identity manager.
